(19) United States
(12) Patent Application Publication
(10) Pub. No.: US 2013/0185909 A1
(43) Pub. Date: Jul. 25, 2013

(54) APPARATUSES AND METHODS FOR ASSEMBLING COMPONENTS INTO ASSEMBLIES USING FIXTURES DEFINING SELF-ALIGNING SURFACES

(71) Applicants: John B. ARDISANA, II, San Francisco, CA (US); Edward L. Siahaan, San Francisco, CA (US)

(72) Inventors: John B. ARDISANA, II, San Francisco, CA (US); Edward L. Siahaan, San Francisco, CA (US)

(73) Assignee: Apple Inc., Cupertino, CA (US)

(21) Appl. No.: 13/358,329

(22) Filed: Jan. 25, 2012

(51) Int. Cl. B23Q 17/00; B23P 21/00

(52) U.S. Cl. 29/407.09; 29/705

(57) ABSTRACT

The present disclosure provides apparatuses configured to assemble components into assemblies and related methods and assemblies. The apparatuses may include a first fixture that is configured to hold a first component, and which defines a first alignment surface. The apparatuses may also include a second fixture that is configured to hold a second component, and which defines a cooperating alignment surface. The alignment surfaces, which may be conical, are configured to self-align when brought into contact with one another such that the components held by the fixtures also come into alignment. Thereby, one of the components may be axially displaced, for example via a plunger, into contact with the other component such that the components are assembled into an assembly.

### FIELD OF THE DESCRIBED EMBODIMENTS

The described embodiments relate generally to assembling components into an assembly. In particular, methods and apparatuses for assembling a plurality of components using fixtures are disclosed.

### BACKGROUND

Modern devices, such as electronic devices, may employ tight tolerances in the assembly of the components thereof. In this regard, tight tolerances may provide for pleasing aesthetic appeal, enable production of a more compact device, and/or provide other benefits. However, the production of devices has become increasingly more difficult in order to accommodate these tight tolerances.

In some embodiments of methods for assembling components into assemblies, optical techniques and robotic equipment may be employed. For example, components may be provided with reference marks thereon which are optically identifiable. Thereby, robotic equipment may employ the reference marks to properly align the components with respect to one another.

While existing assembly methods and apparatuses may function sufficiently for the purposes for which they are intended, further advances in assembly methods and apparatuses may be desirable. In this regard, increased simplicity, speed, and accuracy in assembly may be desirable. Accordingly, it may be desirable to provide improved methods and apparatuses for assembling components into assemblies.

### SUMMARY OF THE DISCLOSURE

The present disclosure generally relates to apparatuses for assembling assemblies from components. One apparatus that may be used to assemble components into assemblies includes a first fixture that is configured to hold a first component and a second fixture that is configured to hold a second component. The first fixture defines an alignment surface and the second fixture defines a cooperating alignment surface that is configured to self-align with the alignment surface of the first fixture. Accordingly, when the alignment surface of the first fixture is brought into contact with the cooperating alignment surface of the second fixture, the first component and the second component may be aligned with respect to one another in internal cavities defined by the fixtures. The first component may then be displaced toward the second component such that the two components are assembled (e.g., via interference fit) into an assembly. Related methods and assemblies are also provided.

Other aspects and advantages of the present disclosure will become apparent from the following.

### BRIEF DESCRIPTION OF THE FIGURES

Having thus described the disclosure in general terms, reference will now be made to the accompanying figures, wherein:

FIG. 1 illustrates a perspective view of an apparatus comprising a first fixture and a second fixture configured to assemble a plurality of components according to an example embodiment;

FIG. 2 illustrates an end view of the first fixture of FIG. 1 showing an alignment surface thereof;

FIG. 3 illustrates an end view of the second fixture of FIG. 1 showing a cooperating alignment surface thereof;

FIG. 4 illustrates a schematic view of the apparatus of FIG. 1, further comprising a plunger, and configured in a loading position;

FIG. 5 illustrates the apparatus of FIG. 4 configured in a position in which first and second components are respectively held by the first and second fixtures;

FIG. 6 illustrates the apparatus of FIG. 4 configured in a position wherein the alignment surface of the first fixture contacts the cooperating alignment surface such that the fixtures and the components are aligned;

FIG. 7 illustrates the apparatus of FIG. 4 configured in the aligned position of FIG. 6, wherein the plunger has axially displaced the first component into contact with the second component such that an assembly is formed;

FIG. 8 the apparatus of FIG. 4 in a separated position after the assembly has been assembled; and

FIG. 9 illustrates an embodiment of a method for assembling a plurality of components according to an example embodiment.

### DETAILED DESCRIPTION

The disclosure now will be described more fully hereinafter through reference to various embodiments. These embodiments are provided so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

In this assembly of modern devices tight tolerances between the various components thereof may be required or desirable for a variety of reasons. For example, in the assembly of a Universal Serial Bus (USB) connector for electronic devices, a metal USB plug may be inserted into a plastic enclosure. The tolerances therebetween may be relatively tight in order to ensure a secure fit is established, provide a pleasing visual appearance without large gaps between the two components, and provide other benefits. However, use of robotic machinery employing optical sensors (or other modern assembly processes and machinery) in the assembly of devices may not be desirable. In this regard, robotic equipment employing optical sensors may be relatively expensive and complicated. In applications such as the assembly of USB plugs, which are available for relatively low prices, use of expensive assembly equipment may not be financially viable. Accordingly, lower cost assembly processes and apparatuses may be desirable.

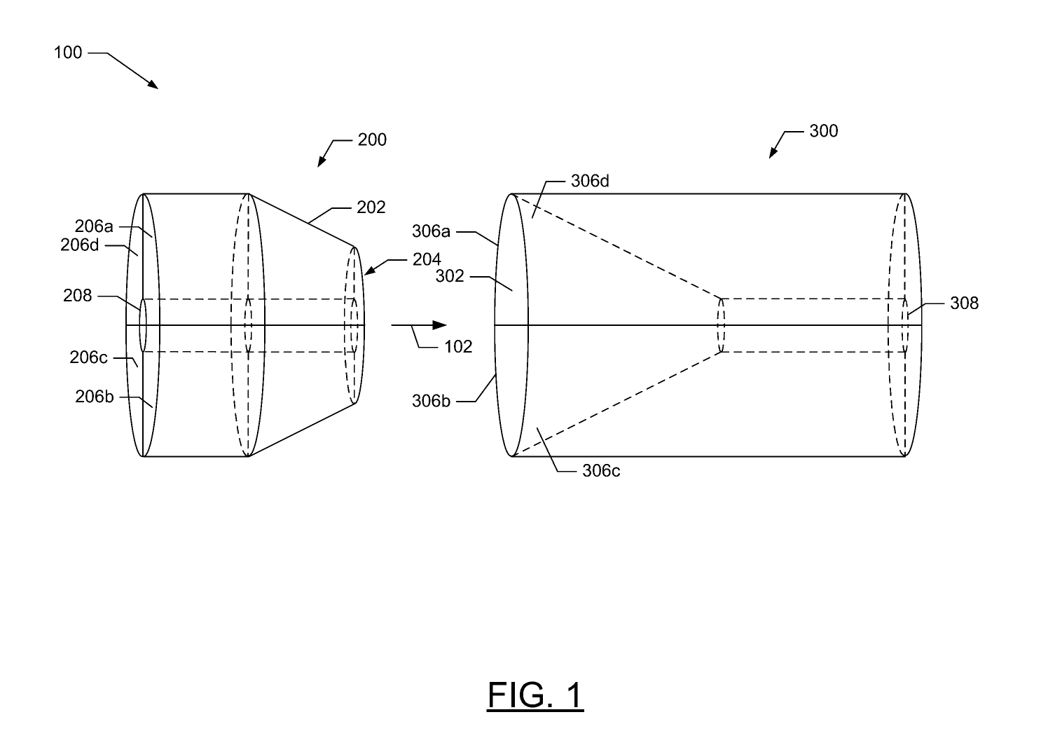

In this regard, FIG. 1 illustrates a perspective view of an apparatus 100 configured to assemble a plurality of components. As illustrated, the assembly 100 may comprise a first fixture 200 configured to hold a first component and a second fixture 300 configured to hold a second component. The first fixture 200 may define at least one alignment surface 202 and the second fixture 300 may define a least one cooperating alignment surface 302. Alignment surfaces, as used herein, refer to surfaces that are configured to contact one another such that a desired alignment therebetween occurs. In this regard, as described in greater detail below, the alignment surface 202 of the first fixture 200 and the cooperating alignment surface 302 of the second fixture 300 may be configured to self-align such that when the alignment surface of the first fixture is brought into contact with the cooperating alignment surface of the second fixture (e.g., when the first fixture is moved in the direction indicated by arrow 102), a first component held by the first fixture is aligned with respect to a second component held by the second fixture.

In particular, in the illustrated embodiment the alignment surface 202 of the first fixture 200 defines a positive alignment surface, and the cooperating alignment surface 302 of the second fixture 300 defines a negative alignment surface. In other words, the alignment surface 202 projects outwardly from the first fixture 200 and is received in a cavity that defines the cooperating alignment surface 302. In some embodiments the alignment surface 202 and the cooperating alignment surface 302 may comprise angled surfaces. For example, the alignment surface and the cooperating alignment surface may define one or more angled planar surfaces. In another embodiment, the alignment surface 202 and the cooperating alignment surface 302 may each respectively define a continuous alignment surface. In this regard, in one embodiment the alignment surface and the cooperating alignment surface may define spherical surfaces. In the illustrated embodiment, the alignment surface 202 and the cooperating alignment surface 302 comprise conical surfaces. In this regard, a conical surface, as used herein, refers to a surface which defines a shape that is substantially similar to that of a cone. However, the conical surface does not necessarily have to extend to a tip or otherwise exactly define the shape of a cone. In this regard, in the illustrated embodiment the first fixture 200 defines an abbreviated cone shape and terminates at an end surface 204.

In order for the fixtures 200, 300 to hold components during the above noted alignment process, the fixtures may comprise a plurality of segments that collectively grasp the components. In this regard, in some embodiments the first fixture 200 may comprise a plurality of segments 206a-d (collectively, “206”). The second fixture 300 may also comprise a plurality of segments 306a-d (collectively, “306”) in some embodiments.

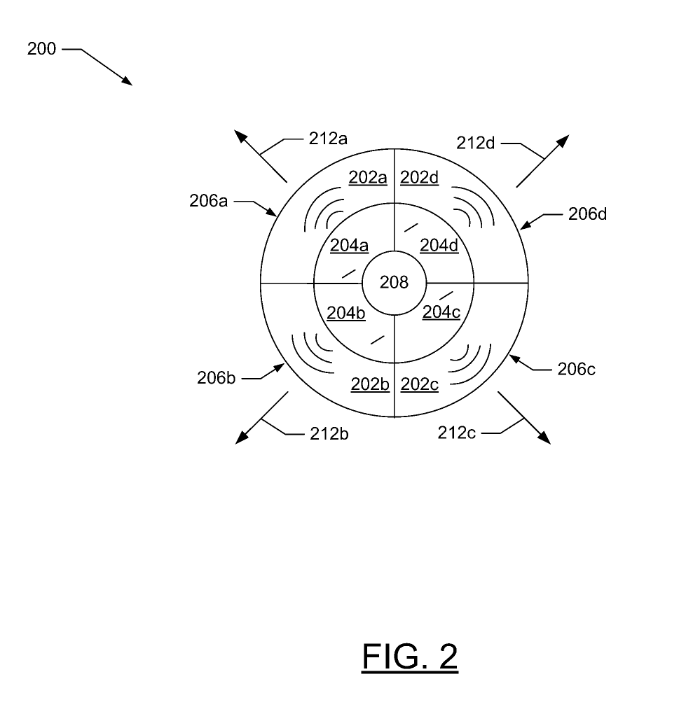

As illustrated in the end view of FIG. 2, in some embodiments the first fixture 200 may comprise four segments 206a-d, which may define equal portions of the first fixture. However, in other embodiments a greater or lesser number of segments 206 may be employed, and the segments do not have to be shaped the same in all embodiments. The segments 206 of the first fixture 200 may cooperatively define a first inner cavity 208 configured to hold a first component. The segments 206 also respectively define portions 202a-d of the alignment surface 202 and portions 204a-d of the end surface 204.

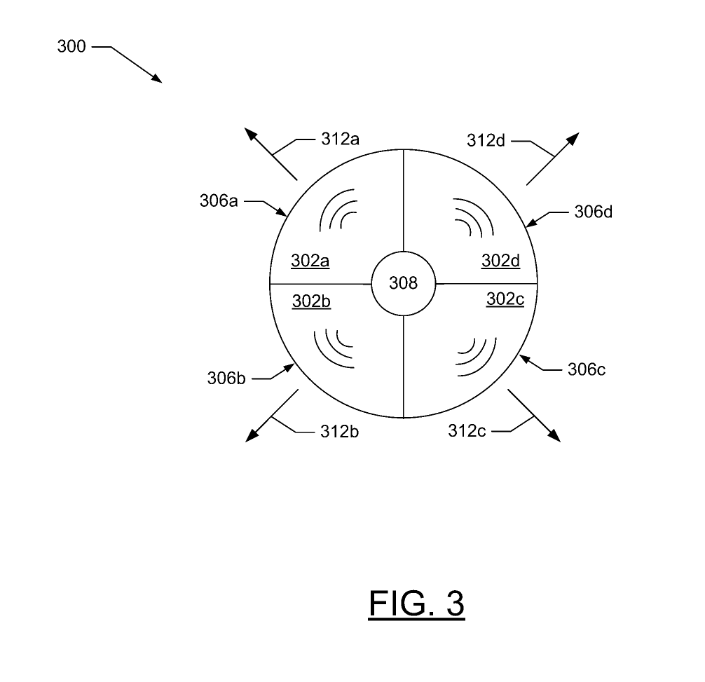

Similarly, as illustrated in the end view of FIG. 3, in some embodiments the second fixture 300 may comprise four segments 306a-d, which may define equal portions of the fixture. However, in other embodiments a greater or lesser number of segments 306 may be employed, and the segments do not have to be shaped the same in all embodiments. The segments 306 of the second fixture 300 may cooperatively define a second inner cavity 308 configured to hold a second component. The segments 306 also respectively define portions 302a-d of the alignment surface 302.

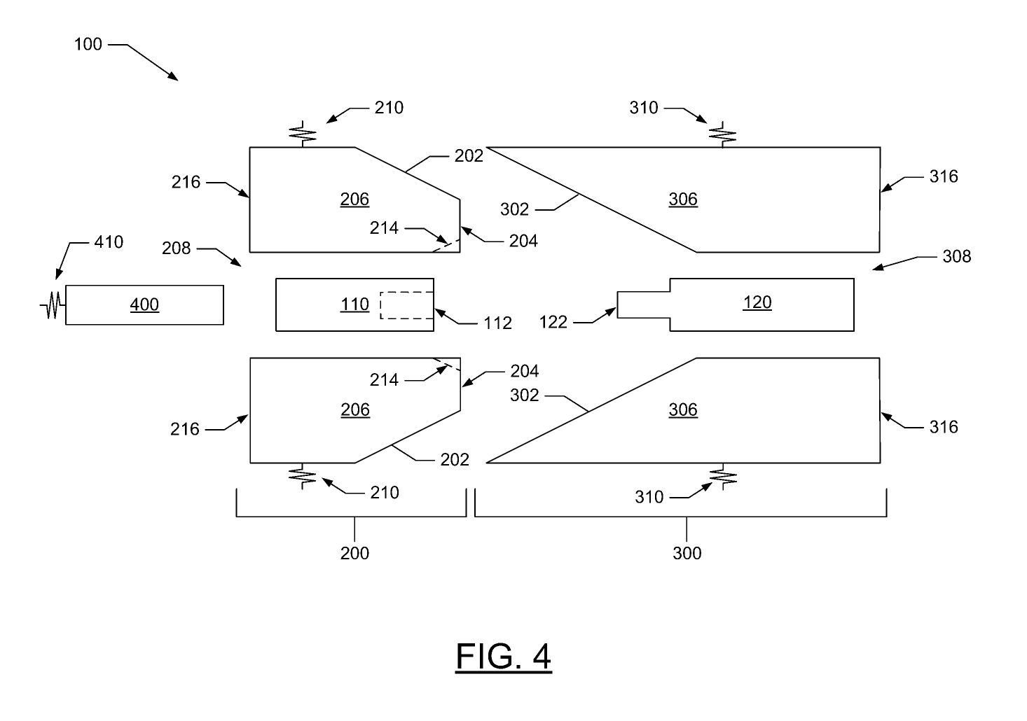

As noted above, the apparatus 100 of FIG. 1 may be employed to assemble components to form an assembly. In this regard, FIGS. 4-8 schematically illustrate the apparatus 100 during example steps employed to assemble a plurality of components. For purposes of simplifying explanation of the operation of the apparatus 100, the segments of the first and second fixtures 200, 300 are respectively referenced by numerals 206, 306, rather than the components thereof 206a-d, 306a-d.

Various embodiments of components may be assembled by the apparatus 100. In one embodiment a first component 110 may comprise a plastic boot that is engaged during assembly with a second component 120 comprising a metal USB plug to define an assembly in the form of a USB connector. In this regard, the first component 110 may include a cavity 112 configured to receive a protrusion 122 defined by the second component therein. However, the components 110, 120 may vary in other embodiments. Further, more than two components may be assembled together in other embodiments.

In some embodiments the assembly 100 may further comprise one or more biasing members 210, 310. The biasing members 210, 310, may be respectively configured to bias the segments 206, 306 of the fixtures 200, 300 toward one another such that the fixtures define the contracted positions illustrated in FIGS. 2 and 3. The biasing members 210, 310, may comprise any components configured to act in accordance with the functionality described below, including springs, clamps, elastomers, and various other components.

However, in order to facilitate loading of the components 110, 120 into the inner cavities 208, 308 of the fixtures 200, 300, the biasing members 210, 310 may be configured to provide for separation of the segments 206, 306 to define a loading configuration, as illustrated in FIG. 4. In this regard, in one example embodiment the segments 206a-d, 306a-d may be configured to move radially outwardly from a contracted configuration, as indicated by the arrows 212a-d, 312a-d in FIGS. 2 and 3. In one embodiment the biasing members 210, 310 may provide for separation of the segments 206a-d, 306a-d by releasing all or a portion of the biasing force on the segments, whereas in another embodiment the biasing members may provide for separation by applying force and/or movement of the segments in the radially outward directions 212a-d, 312a-d.

In another embodiment the biasing members 210, 310 may passively provide for separation of the segments 206a-d, 306a-d by allowing a user to spread the segments apart when inserting a component 110, 120 therein. The cavity defining the cooperating alignment surface 302 may facilitate separation of the segments 306 of the second fixture 300, since the negative cone shape may naturally expand when a component is inserted therein. However, in order to facilitate separation of the segments 206 of the first fixture 200, the first inner cavity 208 may optionally define a tapered opening 214 which facilitates insertion of the first component 110 between the segments (see, FIG. 4). In other embodiments, one or both of outer end surfaces 216, 316 of the fixtures 200, 300 may include a tapered opening to the respective inner cavity 208, 308 such that the components 110, 120 may be loaded through the outer ends in other embodiments.

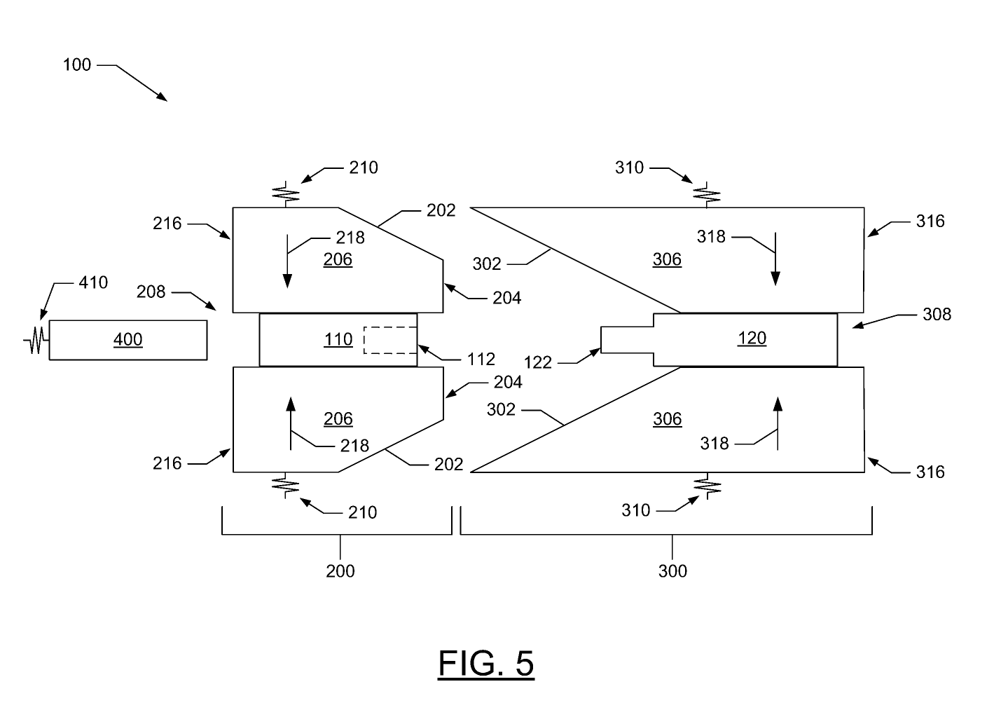

When the components 110, 120 are inserted into the inner cavities 208, 308 of the fixtures 200, 300, the segments 206, 306 may apply force inwardly as indicated by the arrows 218, 318 in FIG. 5. Thereby, the first component 110 and the second component 120 are respectively secured in the inner cavities 208, 308. In this regard, the biasing members 210, 310 may bias the segments 206, 306 into contact with the components 110, 210, such that they hold the components in place.

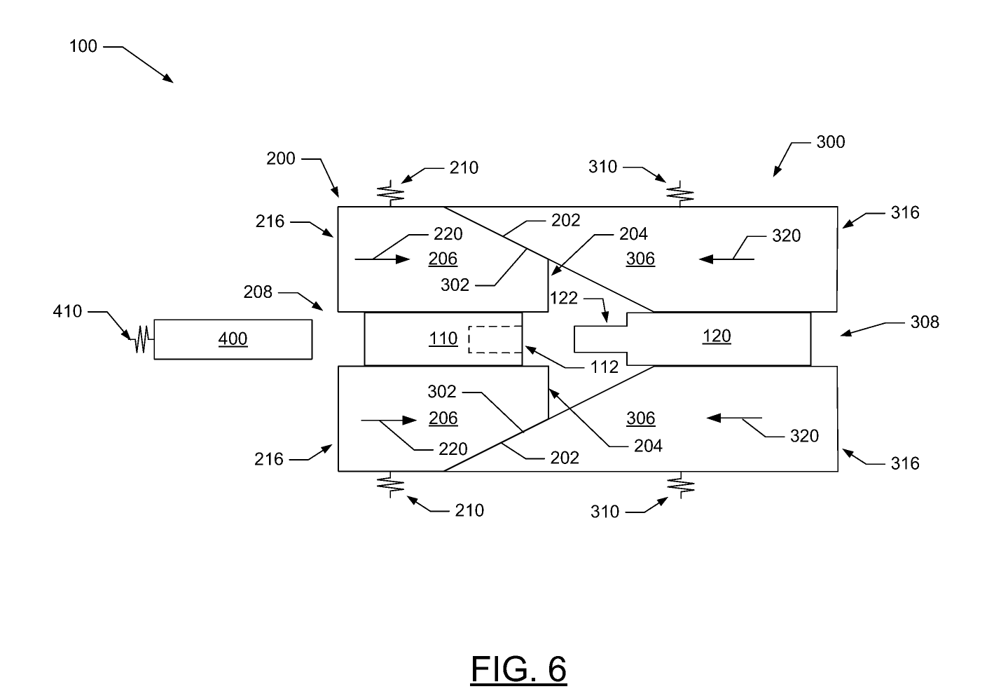

As illustrated in FIG. 6, after the components 110, 120 are secured in the inner cavities 208, 308, the components may be aligned with respect to one another by bringing the alignment surface 202 of the first fixture 200 into contact with the cooperating alignment surface 302 of the second fixture 300, as indicated by the arrows 220, 320. In this regard, both of the fixtures 200, 300 may move, or one of the fixtures may remain stationary. Due to the alignment surface 202 and the cooperating alignment surface 302 defining conical surfaces (or other self-aligning surfaces), the first fixture 200 and the second fixture 300 will axially align with respect to one another. In this regard, since the internal cavities 208, 308 retain the components 110, 120 along respective axes thereof, the components will also axially align with respect to one another.

As noted above, in some embodiments the first fixture 200 may define an end surface 204, which may be planar. The end surface 204 causes the first fixture 200 to define a truncated cone configuration. By truncating the first fixture 200 in this manner, the first fixture 200 may avoid issues with respect to an end thereof overlapping the second component 120, which may require relatively more precise initial alignment of the first fixture with respect to the second fixture 300. However, in other embodiments the first fixture 200 may not include the end surface 214.

As illustrated in FIGS. 4-8, the assembly 100 may further comprise a plunger 400. The plunger 400 may be configured to extend at least partially through one or both of the inner cavities 208, 308. For example, the plunger 400 may be configured to axially displace the first component 110 or the second component 120. In some embodiments the plunger 400 may include a biasing member 410 that is configured to apply a force to the plunger so as to axially displace one of the components 110, 120.

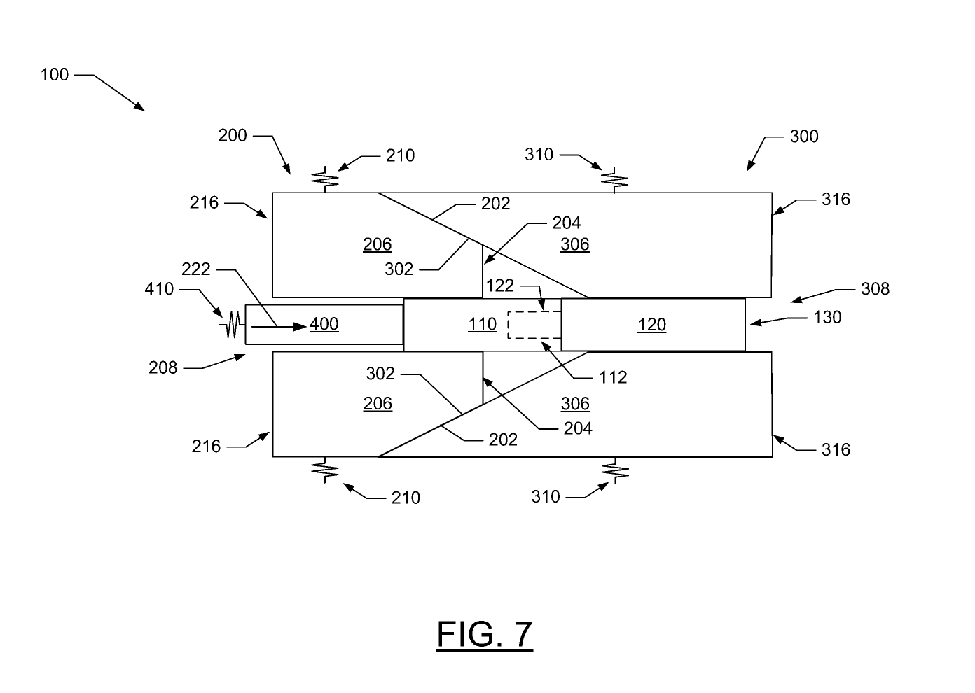

As illustrated in FIG. 7, in one embodiment the plunger 400 may be configured to extend into the first inner cavity 208 and axially displace the first component 110 in the direction indicated by the arrow 222. In this regard, the first inner cavity 208 of the first fixture 200 may be configured to allow for axial movement of the first component 110. For example, the first fixture 200 may comprise a low-friction material defining a smooth surface (e.g., plastic or polished metal) that surrounds the first inner cavity 208.

Conversely, the second inner cavity 308 may be configured to resist axial movement of the second component 120. In this regard, when the plunger 400 pushes the first component 110 into contact with the second component 120, the second component may substantially remain in place such that an interference fit (or other connection) may be established therebetween. Thus, the second fixture 300 may comprise a relatively higher-friction material and/or a rougher surface (e.g., rubber or knurled metal) that surrounds the second inner cavity 308.

By axially displacing the first component 110 into contact with the second component 120, the first component and the second component are assembled into an assembly 130. In particular, in the illustrated embodiment the protrusion 122 defined by the second component 120 engages the cavity 112 defined in the first component 110 to couple the two components via interference fit. However, various other engagement methods may be employed. For example, one or both of the components may include an adhesive on an end thereof that couples the two components.

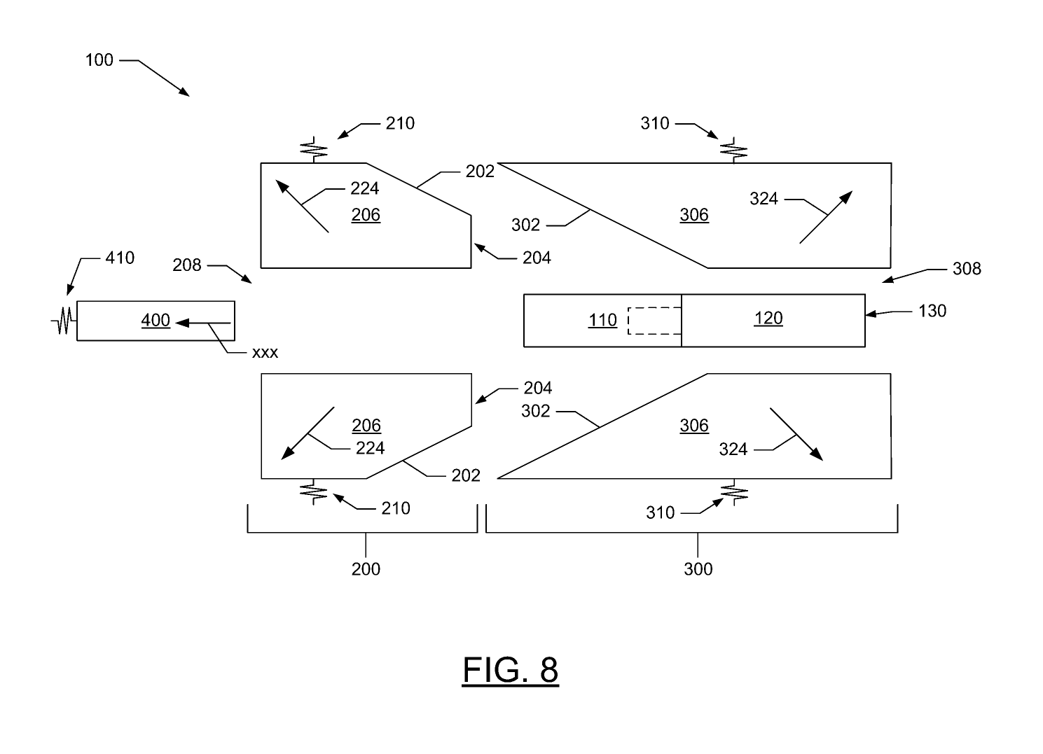

After the two components 110, 120 are assembled to define the assembly 130, the first fixture 200 and the second fixture 300 may be separated, as illustrated in FIG. 8. For example, one or both of the fixtures may be moved in the directions indicated by the arrows 224, 324. By separating the fixtures 200, 300, the assembly 130 formed therein may be removed, and new components may be secured in the fixtures such that additional assemblies may be formed.

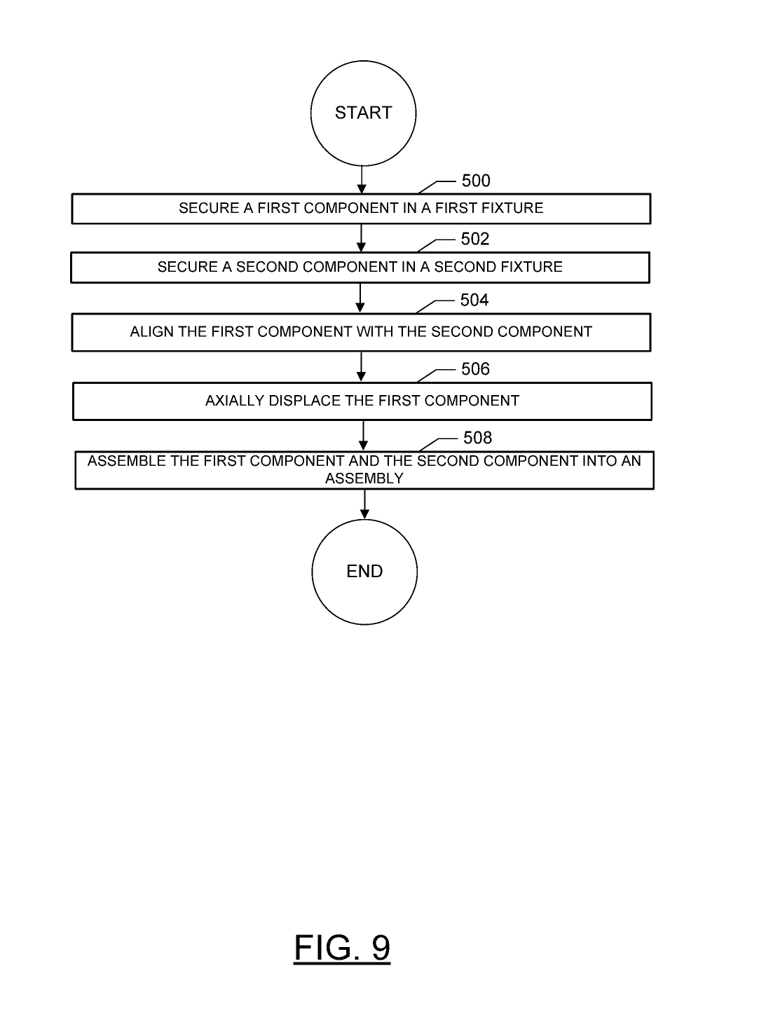

In another embodiment methods for assembling a plurality of components are provided. By way of example, one embodiment of a method for assembling a plurality of components is illustrated in FIG. 9. As illustrated, the method may start and include securing a first component in a first fixture at operation 500. As noted above, in some embodiments the first fixture may define at least one alignment surface. Further, the method may include securing a second component in a second fixture at operation 502. In some embodiments the second fixture may define at least one cooperating alignment surface, wherein the alignment surface of the first fixture and the cooperating alignment surface of the second fixture are configured to self-align.

Securing the first component in the first fixture may include biasing a plurality of segments of the first fixture into contact with the first component. Similarly, securing the second component in the second fixture may include biasing a plurality of segments of the second fixture into contact with the second component. The method may also include providing for separation of the segments prior to securing the first component in the first fixture and/or securing the second component in the second fixture.

Additionally, as illustrated at operation 504, the method may include aligning the first component with respect to the second component. Aligning the components at operation 504 may comprise bringing the alignment surface of the first fixture into contact with the cooperating alignment surface of the second fixture. In this regard, aligning the first component with respect to the second component at operation 504 may include displacing the first fixture toward the second fixture and/or displacing the second fixture toward the first fixture.

The method may further comprise axially displacing the first component relative to the second component at operation 506. Axially displacing the first component relative to the second component may comprise contacting the first component with a plunger in some embodiments. Accordingly, the first component and the second component may be assembled into an assembly at operation 508.

Thereafter, the method may include separating the first fixture and the second fixture after the first component and the second component are assembled into the assembly at operation 508. Further, the method may include removing the assembly from the apparatus. The method may then be repeated as desired to assemble additional assemblies from components, or end.

Notably, the methods and apparatuses disclosed herein may be employed to manually assembly components into assemblies. In this regard, the methods and apparatuses disclosed herein may be employed to hand assemble components into assemblies. In this regard, use of self-aligning surfaces, such as cones, allows for automatic alignment of components. Accordingly, relatively expensive and complex automated assembly methods and equipment (e.g., robots employing optical sensors) may not be needed to construct assemblies requiring relatively high precision alignment of the components thereof. However, the assemblies and methods disclosed herein may also be employed in use with automated equipment.

Many modifications and other embodiments of the disclosure set forth herein will come to mind to one skilled in the art to which the disclosure pertains having the benefit of the teachings presented in the foregoing descriptions. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for assembling a plurality of components, the method comprising:
securing a first component in a first fixture defining at least one alignment surface;
securing a second component in a second fixture defining at least one cooperating alignment surface, wherein the alignment surface and the cooperating alignment surface are configured to self-align;
aligning the first component with respect to the second component by bringing the alignment surface of the first fixture into contact with the cooperating alignment surface of the second fixture; and
axially displacing the first component relative to the second component such that the first component and the second component are assembled into an assembly.

2. The method of claim 1, wherein securing the first component in the first fixture comprises biasing a plurality of segments of the first fixture into contact with the first component.

3. The method of claim 2, further comprising providing for separation of the segments prior to securing the first component in the first fixture.

4. The method of claim 1, wherein securing the second component in the second fixture comprises biasing a plurality of segments of the second fixture into contact with the second component.

5. The method of claim 4, further comprising providing for separation of the segments prior to securing the second component in the second fixture.

6. The method of claim 1, wherein axially displacing the first component relative to the second component comprises contacting the first component with a plunger.

7. The method of claim 1, further comprising separating the first fixture and the second fixture after the first component and the second component are assembled into the assembly.

8. The method of claim 7, further comprising removing the assembly.

9. The method of claim 1, wherein aligning the first component with respect to the second component comprises displacing the first fixture toward the second fixture.

10. An apparatus configured to assemble a plurality of components, the apparatus comprising:
a first fixture configured to hold a first component, the first fixture defining at least one alignment surface;
a second fixture configured to hold a second component, the second fixture defining at least one cooperating alignment surface,
wherein the alignment surface and the cooperating alignment surface are configured to self-align such that when the alignment surface of the first fixture is brought into contact with the cooperating alignment surface of the second fixture, the first component is aligned with respect to the second component, and
wherein the first fixture allows for axial displacement of the first component into contact with the second component such that the first component and the second component are assembled into an assembly.

11. The apparatus of claim 10, wherein one of the alignment surface and the cooperating alignment surface comprises a positive alignment surface and the other of the alignment surface and the cooperating alignment surface comprises a negative alignment surface.

12. The apparatus of claim 10, wherein the alignment surface and the cooperating alignment surface comprise angled surfaces.

13. The apparatus of claim 10, wherein the alignment surface and the cooperating alignment surface comprise conical surfaces.

14. The apparatus of claim 10, wherein at least one of the first fixture and the second fixture comprises a plurality of segments.

15. The apparatus of claim 14, further comprising a plunger configured to axially displace one of the first component and the second component.

16. The apparatus of claim 14, wherein at least one of the first fixture and the second fixture further comprises a biasing member configured to bias the segments towards one another.

17. The apparatus of claim 16, wherein the biasing member is further configured to provide for separation of the segments in order to facilitate loading of one of the components therein.

18. The apparatus of claim 10, wherein the first fixture defines a first inner cavity configured to hold the first component, and
wherein the second fixture defines a second inner cavity configured to hold the second component.

19. The apparatus of claim 18, wherein the first inner cavity is configured to allow for axial movement of the first component, and
wherein the second inner cavity is configured to resist axial movement of the second component.

20. The apparatus of claim 18, wherein at least one of the first inner cavity and the second inner cavity defines a tapered opening.

21. An assembly, comprising:
a first component; and
a second component,
wherein the assembly is formed by:
securing the first component in a first fixture defining at least one alignment surface;
securing the second component in a second fixture defining at least one cooperating alignment surface, wherein the alignment surface and the cooperating alignment surface are configured to self-align;
aligning the first component with respect to the second component by bringing the alignment surface of the first fixture into contact with the cooperating alignment surface of the second fixture; and
axially displacing the first component relative to the second component such that the first component and the second component are assembled into an assembly.

22. The assembly of claim 21, wherein the first component defines a protrusion that engages a cavity defined in the second component.

23. The assembly of claim 22, wherein the first component comprises a universal serial bus plug and the second component comprises a boot.
